(19) United States
(12) Patent Application Publication
(10) Pub. No.: US 2005/0249244 A1
(43) Pub. Date: Nov. 10, 2005

(54) Packet format

(75) Inventors: Darren Phillip McNamara, Bristol (GB); Neil Fanning, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/057,211

(22) Filed: Feb. 15, 2005

(30) Foreign Application Priority Data
Mar. 10, 2004 (GB) 0405443.3

(51) Int. Cl. H04L 12/66

(52) U.S. Cl. 370/474; 370/469

(57) ABSTRACT

The present invention relates to packet construction of format for communications across multiple access networks such as wireless local area networks (WLAN). The present invention provides a device for use in a wireless network and comprising means for generating a packet comprising a first portion having a destination address and preferably a network duration identifier for a recipient device in the network, and a second portion; and means for transmitting the first portion at a predetermined coding and/or modulation rate, and means for transmitting the second portion at a higher coding and/or modulation rate.

### FIELD OF THE INVENTION

The present invention relates to packet construction or format for communications across multiple access networks such as wireless local area networks (WLAN).

### BACKGROUND OF THE INVENTION

Packets sent across multiple access networks require the destination address to be included so that the intended recipient can determine that that the packet is intended for it, and similarly that other devices can determine that they should ignore the packet. In networks utilising noisy or otherwise non-ideal mediums such as wireless networks, packets also require training sequences and other information to enable the devices to properly receive the packet, for example to rectify the effects of interference and variable travel times.

In an IEEE 802.11a WLAN, all packet transmissions are separated into three parts, as shown in FIG. 1. The first is the PLCP (Physical Layer Convergence Protocol) preamble for synchronisation and channel estimation, the second is the PLCP ‘Signal’ field which is transmitted at a low (robust) rate, and the third contains the PLCP ‘Service’ field and the data payload or PSDU (Physical layer Service Data Unit) which are transmitted at a higher rate if possible.

The PLCP preamble contains 12 known OFDM symbols which allow the receiver to compare the received symbols with its own local copy of what was transmitted in order to “correct” for the effects of a multipath channel, and also to enable proper synchronisation and estimation of frequency offsets. The PLCP signal field contains one OFDM symbol which carries a number of bits providing information on what rate the following “payload” part of the packet is transmitted at, as well as its length.

The final part of the packet comprises the service field of 16 bits which are also used for synchronisation, and the PSDU, the structure of which is shown in FIG. 2. The PSDU comprises MAC header fields including the destination device MAC address (address 1) and the sending device MAC address, as well as the traffic or message data. This part of the packet is typically transmitted at a higher coding and/or modulation rate in order to more efficiently and quickly transfer its contents. The second part of the packet is typically transmitted at a low coding/modulation rate in order to improve the probability of its correct reception and decoding.

Wireless networks that do not have centralised Medium Access Control (MAC), such as the IEEE 802.11 family when in the DCF mode of operation, do not provide an explicit Negative ACKnowledgement (NACK) mechanism. ACKnowledgements (ACKs) are transmitted by a device upon the successful receipt of a data frame to inform the device that transmitted the data frame of the receipt. This is shown in FIG. 3. Several factors, such as collisions, external interference and un-robust PHY modes can lead to a data frame not being successfully received as there is either not enough signal power or there is interference. It is clearly difficult to implement a system to send a NACK when a data frame is not successfully received because the intended recipient does not always know if an unsuccessful transmission was destined for it. NACKs can however be implied by the device that transmitted the data frame when it does not receive an ACK within the expected time, as illustrated in FIG. 4. Alternatively, the data frame could be received successfully and it is the ACK that is not received by the original transmitter. The sending device will not however know why the frame exchange sequence failed.

### SUMMARY OF THE INVENTION

In general terms the present invention provides a packet format or construction for use in a wireless network in which the packet comprises a portion which is intended for transmission at a lower transmission rate, and which contains the destination address of the packet. This portion preferably also contains the duration or remaining duration over which the network medium will be determined as being busy. This portion is transmitted at a lower rate in order to make its reception more robust to noise for example, and also to allow all devices in the network to be able to access its contents. By transmitting the destination address in this portion, a device can determine if it is the intended destination and if not there is no need for it to try to decode the rest of the packet. This reduces power consumption by those devices which are not the intended recipient.

This compares favourably with known IEEE 802.11 standards which employ a packet having a lower rate portion and a higher rate portion, but in which the address is contained within the higher rate portion requiring all devices in the network to decode this. However a device or terminal may not have the capability to decode this higher rate portion or last part of a packet (PLCP ‘service’+PSDU), either because it does not support the transmission mode (the higher coding and modulation scheme, or multiple antenna transmission scheme) that is being employed, or because the received signal quality is insufficient to decode transmissions in this mode. Since the terminal cannot tell in advance whether it is the intended recipient of a certain packet, it must attempt to fully decode the packet in order to try and obtain the MAC address of the packet's destination and the duration of the frame exchange sequence (both are contained in the PSDU—see FIG. 2). Even if the packet is not intended for the receiving terminal, without the duration information the terminal's Network Allocation Vector (NAV) cannot be updated, and its virtual carrier sense mechanism is rendered inoperable. This will lead to an increased risk of packet collisions if the terminal is unable to ‘hear’ all other terminals in the network. Also, under this scheme, the necessity for a terminal to decode an entire packet in order to just discover whether or not it is the intended recipient imposes an additional power drain on the device above that necessary to just decode its own packets.

In particular in one aspect the present invention provides a packet format for use in a wireless network in which the packet comprises a first portion for transmission at a first transmission rate, and a second portion for transmission at a second transmission rate, wherein the first portion is at the lower rate and comprises the destination address of the packet.

The term transmission rate is a general term intended to encompass a variety of mechanisms for varying the rate at which symbols are transferred over a network; and includes for example changes in rate due to variations in coding, modulation, the number of antennas employed, or the method by which multiple antennas are employed. Thus for example the first portion may be transmitted using a single antenna whilst the second portion is transmitted using a multiple antenna scheme.

Preferably the first portion also comprises a duration value relating to the remaining length of time the medium or network will be occupied with the packet or frame exchange sequence. This is associated with the NAV counter in IEEE 802.11 based systems.

Preferably the first portion further comprises the transmission parameters of the second portion. This might include the coding and/or modulation rate of the second portion, or whether it is using a multiple transmit antenna scheme.

Preferably the first portion further comprises the length of the second portion.

Preferably the packet further comprises an estimation and synchronisation portion transmitted prior to the first portion.

The first portion may comprise the MAC address in the case of IEEE802.11 based protocols, or a short network based address for the recipient device. It may also comprise the sending address which may be useful for some applications.

This allows all terminals to be able to decode the MAC address of the recipient terminal, or some other indication of the recipient terminal, and the duration of the frame exchange sequence. This is achieved without requiring all terminals to decode (or have the ability to decode) the full packet.

There is also provided a device for use in a wireless network and comprising: means for generating a packet comprising a first portion having a destination address for a recipient device in the network, and a second portion; and means for transmitting the first portion at a predetermined transmission rate, and means for transmitting the second portion at a higher transmission rate.

Preferably the transmission means is arranged to employ BPSK OFDM for transmitting the first portion. Preferably the device is arranged to operate according to an IEEE 802.11 standard.

The destination address in the first portion may be determined from the second portion. For example the destination address is copied from the second portion. Or the destination address can be a shortened version of the address from the second portion. As a further alternative the destination address can be the recipient device's association identifier.

Preferably the device is implemented using PLCP layer software running on a processor.

Preferably the device further comprises means for receiving a negative acknowledgement (NACK) from the intended recipient of the transmitted packet. This may comprise feedback information. The device may be further arranged to re-transmit the packet upon receipt of the NACK.

The second portion may then be re-transmitted at a lower transmission rate than for the second portion of the first transmission.

The NACK may comprise the device's address, or the intended recipient's address and not the devices address, or both.

There is also provided a corresponding receiving device having means for receiving a first portion of a packet at a predetermined transmission rate, and means for receiving a second portion at a higher transmission rate; and means for determining a destination address for a recipient device in the network from the first portion.

Preferably the device is arranged to instruct decoding of the second portion if the destination address matches an address for said device.

Preferably the determining means is further arranged to determine a duration identifier corresponding to the duration over which the network will remain occupied. Preferably the determining means is further arranged to determine the transmission parameters of the second portion, and the length of the second portion, from the first portion.

Preferably the device further comprises means for transmitting a negative acknowledgement (NACK) to the device sending the packet if the device is unable to decode the second portion of the transmitted packet.

In particular in another aspect there is also provided a signal for use in a wireless network, the signal comprising a packet format having a first portion comprising a destination address for a recipient device in the network, and a second portion; wherein the first portion has a predetermined transmission rate, the second portion has a higher transmission rate.

Preferably the signal further comprises a duration identifier corresponding to the duration over which the network will remain occupied.

There are also provided corresponding methods for implementing the functions associated with the above-defined devices. These may be implemented in software and/or hardware such as ASIC's for example.

In general terms in a further aspect the present invention provides a method of using negative acknowledgements for a wireless network. As the more robust first portion of the packet, for example PLCP header, transmission includes the destination address for example the MAC address information in the signal field, then the receiving device knows that failed, less robust, data transmissions were destined for it and so can provide Negative Acknowledgements (NACK). This compares favourably with known systems in which the receiver may not know that the failed packet was intended for it if it was unable to decode the packet. In some cases feedback can also be provided for link adaptation, for example indicating that the receiving device cannot receive the higher modulation rate of the payload part of the packet, such that on retransmission the sending device can resend this at a lower modulation rate, or with different suggested modulation parameters, and possibly in a more robust manner.

Preferably the NACK comprises feedback information, including reasons why the reception of the packet failed, for example because the receiver could not receive the higher modulation rate used, or because there was too much noise. This can then be used by the transmitter to re-send the packet, and this might include re-sending the packet at a lower modulation rate that the receiver can handle, or simply re-sending the packet at the same rate in the case of noise.

In particular in this further aspect there is provided a device in an ad hoc network having means for receiving a packet, means for determining whether the packet is addressed to the device, means for determining whether the packet was correctly received, and means for sending a negative acknowledgement (NACK) to the sending device if the packet was addressed to the receiving device but was not correctly received.

Previously it has not been possible in ad hoc networks to explicitly send NACK's because the receiving device does not know whether an incorrectly received packet was addressed to it, and so an implied negative acknowledgement system is used. However there is provided a mechanism for determining that the packet was addressed to the device and that it was not received correctly or fully. In particular at two rate packet is sent, a first portion at a lower rate has the destination address which can be checked by the receiving device, and a higher rate portion contains the payload. If the first portion is correctly received, but the second higher rate portion is not, then the device can send a negative acknowledgement to the sending device.

There is also provided a sending device which sends a packet in an ad hoc network, and is arranged to receive a negative acknowledgement (NACK). Upon receipt of the NACK, the sending device can re-send the packet. This may or may not include changing the rate at which the second portion is transmitted.

There is also provided corresponding methods for implementing these functions, and which may be provided as computer programs.

### BRIEF DESCRIPTION OF THE DRAWINGS

Embodiments will now be described with reference to the following drawings, by way of example only and without intending to be limiting, in which:

FIG. 1 shows the structure of an IEEE 802.11a WLAN packet;

FIG. 2 shows the structure of the PSDU parts of the packet of FIG. 1;

FIG. 3 shows a known method of acknowledging receipt of a packet;

FIG. 4 shows a known implied negative acknowledgement scheme;

FIG. 5 shows a modified packet structure according to an embodiment; and

FIG. 6 is a schematic illustrating operation of the protocol layers in network devices according to an embodiment.

FIG. 7 shows a method of utilising a negative acknowledgement scheme according to an embodiment;

FIG. 8 shows a modified frame exchange sequence for a packet initially received with errors, and a retransmission successfully received; and

FIG. 9 shows a modified frame exchange sequence for a packet initially received with errors, a retransmission received with errors and a second retransmission successfully received.

### DETAILED DESCRIPTION

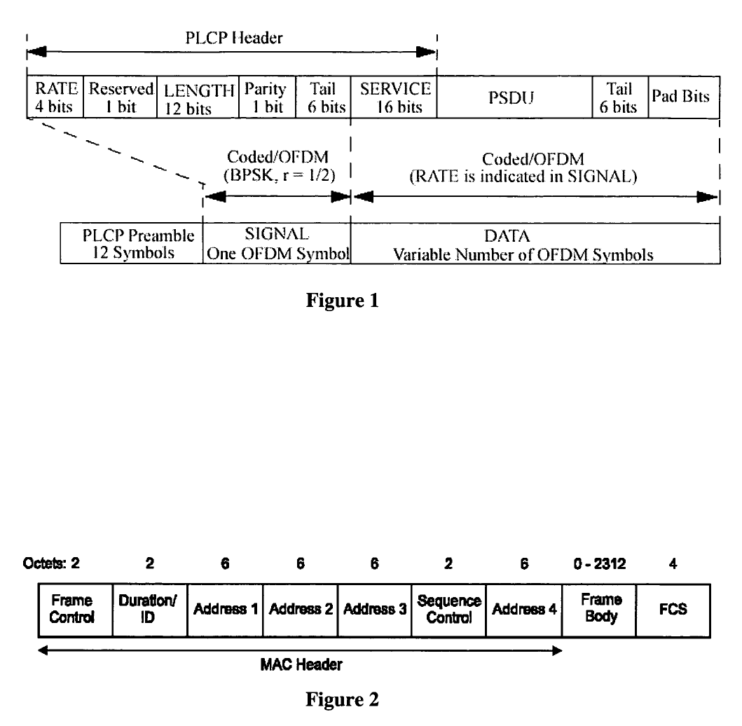

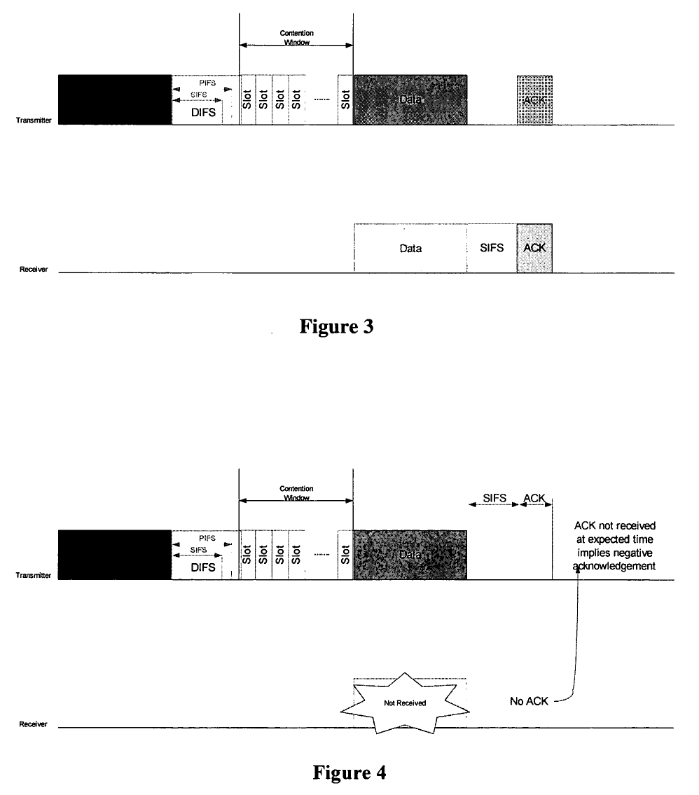

As already discussed, Wireless networks such as the IEEE 802.11 family, that support multiple physical layer (PHY) modes with differing throughput rates and levels of robustness can use a protocol in the PHY such as the Physical Layer Convergence Protocol (PLCP). The purpose of protocols such as PLCP is to abstract the MAC from the details of a particular PHY. It includes features to facilitate synchronisation, frequency offset estimation, channel estimation and indication of the mode at which the payload, Medium Access Control (MAC) Protocol Data Unit (MPDU) will be transmitted. An example of a PHY Protocol Data Unit (PPDU) using PLCP is shown in FIGS. 1 and 2. The preamble deals with synchronisation, frequency offset estimation and channel estimation. The signal field, which is transmitted at the most robust and hence lowest rate PHY mode, conveys the length of the PSDU payload and the PHY mode at which it will be transmitted. The data field contains the PSDU payload and this can be transmitted at a higher rate less robust PHY mode than the PHY header.

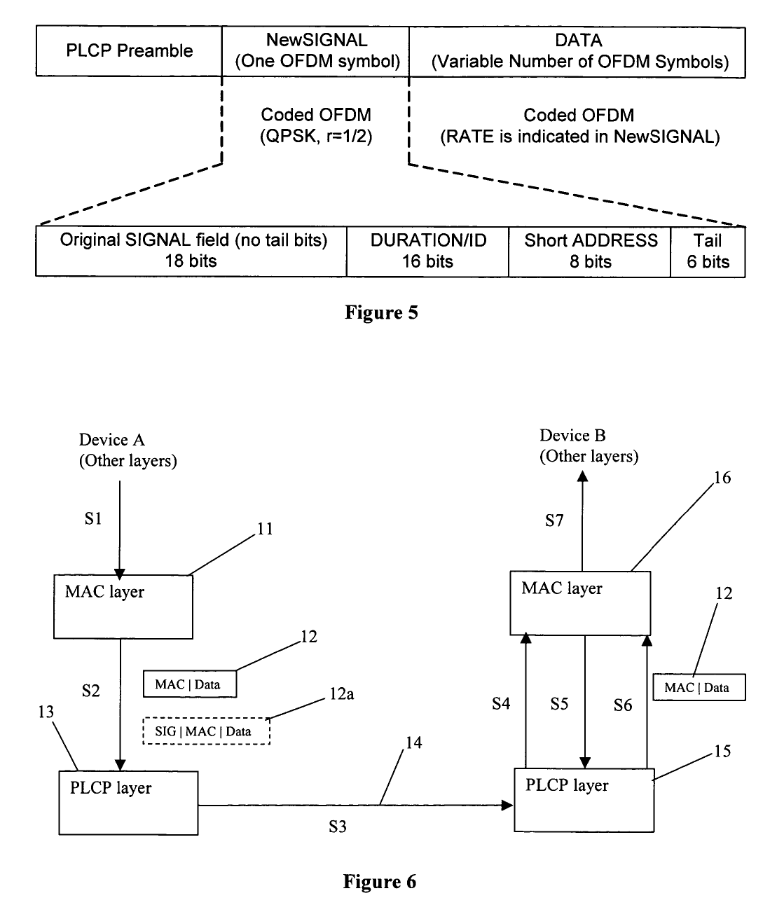

Referring to FIG. 5, a modified packet structure is shown which is similar to the 802.11a packet of FIGS. 1 and 2. The preamble and PSDU parts of the packet are the same, however a modified signal part (NewSIGNAL) is employed which includes the rate of the third part (service+PSDU) and its length, and additionally includes the remaining duration of the frame exchange sequence (DURATION/ID) and a short address for the intended recipient (Short ADDRESS).

The MAC either supplies this extra information to the PLCP explicitly, or if a standard 802.11 MAC header is assumed, the information can be copied from known locations in the PSDU (Duration/ID and address 1 fields in FIG. 2). The NewSIGNAL field is still transmitted with a robust (ie low rate) modulation and coding scheme. For example maintained as BPSK with a ½ rate code, so that the NewSIGNAL field spans 2 OFDM symbols, or with the use of QPSK instead, the information could be contained in 1 OFDM symbol. The latter option (as illustrated in FIG. 5) removes any increase in frame duration, but will provide the benefits of communicating this extra information. Of course, other alternative modulation and coding schemes could be employed.

Although the example shown in FIG. 5 has the NewSIGNAL field containing all the information from the original SIGNAL field, as well as the additional information, this need not necessarily be the case. Since this change requires a change from the 802.11a standard, a complete change in the other information contained in the NewSIGNAL field is also possible. Either way, the DURATION and ADDRESS information is communicated in the initial part of a frame, and is modulated and encoded such that all terminals can decode this (and have a high probability of decoding it successfully). An alternative method would be to encode the original signal field as usual, and to then include all new information in a second OFDM symbol. Further methods for the inclusion of this information in the initial part of the packet would be obvious to those skilled in the art.

The contents of DURATION/ID in the NewSIGNAL field are the same 16 bits that are contained in the corresponding field of the MAC header (FIG. 2). The ADDRESS component of the NewSIGNAL field is to indicate the immediate intended recipient of the frame being transmitted (this is always contained in ADDRESS1 of the MAC header—see FIG. 2). In the simplest case, this 48 bit field could be transmitted in its entirety, although this would significantly extend the length of the NewSIGNAL field. Alternatively, a reduced length address could be employed (as illustrated by the example in FIG. 5). This field would still be large enough to cope with a sufficiently large enough number of concurrent users but would significantly reduce the number of bits required to identify each terminal. As a further alternative the short address could be a variable length address. The DURATION/ID and ADDRESS information could either be copied from the MAC header, or passed to the PLCP as a separate item and removed from the MAC header, consequently saving their repetition.

Another alternative to the transmission of the recipient's full MAC address in the PLCP header is for a subset of bits to be selected as a ‘shortened’ address. These shortened addresses would be formed by selecting a number of bits, e.g. 8 or 16 from the full 48-bit MAC address, according to a specified bit selection pattern which would be common for all stations. The exact number and pattern of these bits would be chosen to limit the probability of two or more stations both generating the same shortened address to an acceptable value. Although some address duplication may occur between shortened addresses, negating some of the benefits of placing addresses in the PLCP header, this technique would still allow the majority of the power saving benefits to be obtained. Even if a shortened address is matched by two or more stations, only these stations will then incur the power drain of having to fully detect and decode the remainder of the packet to then obtain and check the full MAC addresses.

Another alternative to the transmission of the recipient's MAC address in the PLCP header, for 801.11 based systems operating in an infrastructure network, is to transmit the recipient's Association ID (AID) in this field. The AID is a short address allocated to a station when it associates with an access point. The access point will know which AID is allocated to each station, and each station will know the AID of the access point. In this infrastructure mode of operation, direct communication is normally only allowed between stations and the access point and devices therefore do not need to know the AIDs of other devices.

On reception of a packet, the PLCP (Physical Layer Convergence Protocol) layer (layer 1) at the receiver would detect and decode the NewSIGNAL field. The DURATION and ADDRESS parts (expanded to the full 48 bits address if necessary, or possible) could then be passed to the MAC (media access control) layer (layer 2). If the MAC layer decides that it is the intended recipient, the PLCP layer will not be told to stop processing the rest of the packet. Detection of the full packet will continue as normal. If the terminal is not the intended recipient, the MAC layer can update the NAV (Network Allocation Vector) according to the DURATION information and instruct the PLCP layer to stop any further processing on the packet being received.

The NAV indicates how long the network will be busy for, such that the device doesn't contend for access during this time, in order to avoid packet collisions. By including duration information in the robust part of the packet, it is more likely all the devices in the network will be able to decode it, and therefore the incidence of packet collision will be reduced.

Since the NewSIGNAL field is transmitted in a robust format, and generated such that all terminals have the ability to decode it, they should all be able to update their NAV, no matter whether they have the capability or received signal quality to decode the PSDU. This is especially important in MIMO systems since there will be a greatly increased chance that a strong signal may be received, but the PSDU will be impossible to decode if the receiver does not have the required capabilities or a suitable channel response.

The transmission of the recipients ADDRESS information as part of the PLCP header allows an early decision to be made about whether the remainder of the packet needs to be decoded or not. If this is not necessary, decoding can be stopped; saving power. Again, this will be especially important for MIMO transmissions where the processing required to detect and decode each packet can be significant.

It is possible that the inclusion of this extra information in the PLCP header could extend the duration of a packet (although an example has been shown in FIG. 5 where this could be avoided). In such a case, the throughput of the system would be slightly reduced in situations where collisions do not exist and hence knowledge of the DURATION information is of little use. The advantages of being able to obtain early checking of the recipients ADDRESS would still be available.

An embodiment is described with respect to FIG. 6 in which a sending device A transmits data to a recipient device B. In a first step (s1), the higher protocol layers of device A instruct its MAC layer 11 to forward this data to device B. The MAC layer 11 adds a MAC header similar to that of FIG. 2 to the data and passes this (layer 2) packet 12 down to the physical (PHY) layer which in this case is the PLCP layer 13—step s2. The MAC layer 11 may also instruct the PLCP layer 13 to add the MAC or a short address to its signal field, or alternatively may pass a partially completed layer 1 (PLCP) packet 12a to the PLCP layer 13. The MAC layer can copy this information directly from the recipient address (of device B) of the MAC header, or use more intelligent processing to derive its short address and/or remove the MAC recipient address of device B from the MAC header.

For clarity the internal steps of the layers are not shown, however those skilled in the art will appreciate the known protocol steps for a number of protocols such as IEEE802.11a for example. With the functional requirements detailed here, a skilled programmer will also be able to modify or create the necessary software to implement these layers. Detailed instructions relating to function steps of the IEEE802.11a protocol can for example be found in “Wireless LAN Medium Access Control (MAC) and Physical Layer (PHY) specifications: High-speed Physical Layer in the 5 GHZ Band”, IEEE Std 802.11a-1999; and “Wireless LAN Medium Access Control (MAC) and Physical Layer (PHY) Specifications”, ANSI/IEEE Std 802.11, 1999 Edition. In this example protocol particular attention is drawn to sections 7.1.2, 7.2, 9.2, 9.2.5.4, and 17.3.

The PLCP layer 13 generates the full layer 1 or PHY packet for transmission across the wireless medium 14. The packet corresponds to that shown in FIG. 5 and comprises the recipient address and duration information in the signal field. This field is either created in this layer 13 using the layer 2 packet 12 and the further data from the MAC layer 11, or using the partially created PLCP packet 12a passed on by the MAC layer 11. At step s3 the full packet is transmitted across the wireless network 14 using the appropriate level of coding and/or modulation for each part, and is received by the recipient device B.

The PLCP layer 15 of device B starts receiving the packet and uses the preamble to synchronise and equalise the rest of the packet. The PLCP layer 15 decodes the signal part of the packet to recover the recipient address and duration information, which is passed up to the MAC layer 16 of the recipient device B in step s4. The MAC layer 16 determines whether the recipient address corresponds to its own address, and if not instructs the PLCP layer 15 to stop decoding the rest of the packet (step s5); noting however the duration parameter so that it doesn't attempt contention for the network's medium for this period. If however device B is the recipient address, the MAC layer 16 instructs the PLCP layer 15 to continue decoding the rest of the packet (step s5); or alternatively does nothing allowing the PLCP layer 15 to continue.

At step s6, the PLCP layer 15 passes the MAC layer 16 the recovered layer 2 packet 12 including the MAC header and data. The MAC layer 16 then removes the header information and passes the data on up to the higher layers in the device B (step s7).

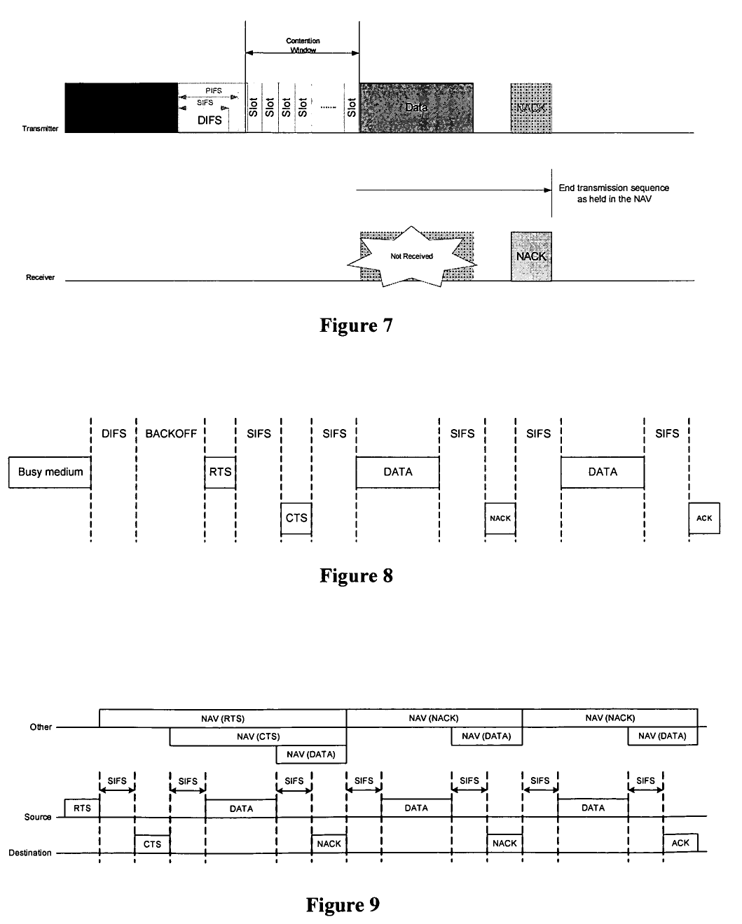

In a further embodiment, a negative acknowledgement scheme is provided utilising the improved packet format. The MAC address or some other indication of the intended recipient is now in the PHY header which is transmitted at the most robust PHY mode and so has the highest probability of being received successfully. The receiving device now knows that it is the intended recipient without having to decode the payload of the PPDU. The payload of the PPDU will then more than likely be transmitted at a higher rate less robust PHY mode. If the receiver fails to properly receive the payload, either because of interference or because the PHY mode is not robust enough, it now has the ability to send a negative acknowledgement (NACK) frame in response, as shown in FIG. 7.

In one arrangement the PLCP signal part of the packet is expanded to include the Source Address (SA) of the transmitting device, in addition to the Destination Address (DA) of the intended recipient device. The DA of the NACK would be the SA from the PLCP header of the unsuccessfully received data frame. For systems that use NAVs, such as the 802.11 family, the NACK would be sent at the time defined by subtracting a NACK duration from the value of the NAV held by the intended recipient. Alternatively, the time to send the NACK could be determined through use of the rate and length information in the PLCP signal field to calculate when the data transmission will end, and then deferring for the usual short inter-frame space (SIFS) period.

In an alternative arrangement, the SA is not included in the PLCP header (signal field). In this scheme, if a recipient device fails to successfully receive a data frame then it could transmit a NACK containing its own MAC address, or other address indication sent in the PLCP header. After sending the data frame, the transmitting device then listens either for an ACK or a NACK with the DA the same as the device to which it sent the preceding data frame. This is advantageous in circumstances where it is not be desirable to include the SA, even if it is removed from the MAC. For example if the PLCP header is transmitted on a PHY mode that has a significantly lower rate than that used for the payload, it will take longer to transmit this information. However without the SA, a recipient device will not know the DA to use for a NACK if a data frame was not received successfully. This scheme overcomes this problem.

Following receipt of a NACK, there are two options for how the device transmitting the data should proceed. One method would be to contend for medium access again, which in the case of the 802.11 family would involve the use of a DCF (Distributed Coordination Function) Inter Frame Space (DIFS) and then a random back off contention window, as illustrated in FIG. 7. This ensures fair medium access amongst all nodes in the network.

Alternatively, using the 802.11 MAC protocol as an example, the receiver could wait for a Short Inter Frame Space (SIFS) before retransmitting the data frame, consequently denying other stations access to the channel until after the retransmission. This process could continue until an ACK signifying successful receipt is received by the transmitter of the data as shown in FIG. 8. In order to avoid unfair continued use of the medium until the transmission is successful, the number of retransmissions allowed in this way would be limited. If the recipient has still not successfully received the packet after this retransmission count limit (e.g. 2 or 3 attempts), it will release access to the medium in the usual way by not transmitting anything following the last DATA packet, and allowing a DIFS (DCF inter-frame space) silent period to elapse so that all stations can again contend for access to the channel.

During retransmissions following the above scheme, the DURATION field in each NACK packet is set by the MAC to update the NAV of other terminals, and is set to the length of the DATA packet plus the length of 2 SIFS periods plus the length of another NACK or ACK (see FIG. 9). The DURATION value in a DATA packet is calculated normally (1 SIFS+length of the ACK). A sequence of retries immediately following NACKs is only possible if the retransmitted packet has the same duration as the previous DATA packet, in order to allow correct calculation of the NAV information. If this behaviour (sequence of retires) is not desired, then there is still an advantage in sending a NACK instead of no ACK (as in conventional systems), as this would still allow information to be passed to the originator, aiding link adaptation.

For each retransmission the originator could reconsider and possibly change the rate (PHY mode) at which the data packet is transmitted or perhaps use the RTS-CTS mechanism or packet fragmentation if these are not already being employed. These methods are well known to those skilled in the art. It would also be possible for NACK packets to be defined to contain information for feedback to the originator that could aid the retransmission. Depending upon the PHY technology used it may be possible to determine if the failed reception was due to a collision or if it was due to a lack of robustness. This may be especially useful in a system employing multiple-input multiple-output (MIMO) antenna technology, where information about the channel, bit-loading, or other information may be communicated.

The embodiments generally utilise the new packet format to determine from the PHY header that the receiving device is not the intended recipient such that it need not decode the remainder of the transmission in order to conserve power. However, there are circumstances when it makes sense for a device to periodically decode the remainder of frames for which it is not the intended recipient. This allows the device to perform Link Adaptation in advance of data transfer without the need for extra overhead and wasted transmissions.

From the robust PHY header a device can determine the sender of the intercepted frame and the rate at which the payload will follow. If the payload cannot be decoded then the intercepting device can determine that a more robust PHY mode will be required when it attempts to transmit to that particular device. The intercepting node can also keep track of the highest rate PHY mode that will allow successful transmission to a particular device by monitoring successfully received transmissions.

The embodiments also provide the ability to use a Hybrid Automatic Repeat reQuest (HARQ) scheme. HARQ requires a device to know that it was the intended recipient of a failed transmission so that it can store the received packet, which it did not decode successfully, to assist the detection of the re-transmission.

Whilst the embodiments have been described with respect to variants of the IEEE 802.11 standard, they are equally applicable to other wireless standards with suitable modifications as would be understood by those skilled in the art. With suitable modifications the embodiments may also be implemented in non-wireless networks.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A device for use in a wireless network and comprising:
means for generating a packet comprising a first portion having a destination address for a recipient device in the network, and a second portion;
means for transmitting the first portion at a predetermined transmission rate, and means for transmitting the second portion at a higher transmission rate.

2. A device according to claim 1 wherein the first portion further comprises a duration identifier corresponding to the duration over which the network will remain occupied.

3. A device according to claim 2 wherein the first portion further comprises the transmission parameters of the second portion, and the length of the second portion.

4. A device according to claim 1 wherein the transmission means is arranged to employ BPSK OFDM for transmitting the first portion.

5. A device according to claim 4 wherein the device is arranged to operate according to an IEEE 802.11 standard.

6. A device according to claim 1 wherein the generating means comprises means for determining the destination address from the second portion.

7. A device according to claim 6 wherein the destination address is copied from the second portion.

8. A device according to claim 6 wherein the destination address is a shortened version of the address from the second portion.

9. A device according to claim 5 wherein the destination address is the recipient device's association identifier.

10. A device according to claim 1 wherein the transmitting means and the generating means comprise PLCP layer software running on a processor.

11. A device according to claim 1 further comprising means for receiving a negative acknowledgement (NACK) from the intended recipient of the transmitted packet.

12. A device according to claim 11 wherein the NACK comprises feedback information.

13. A device according to claim 11 further comprising means for re-transmitting the packet.

14. A device according to claim 13 where the second portion is transmitted at a lower transmission rate than for the second portion of the first transmission.

15. A device according to claim 11 wherein the NACK comprises the device's address, or the intended recipient's address and not the device's address.

16. A device for use in a wireless network and comprising:
means for receiving a first portion of a packet at a predetermined transmission rate, and
means for receiving a second portion at a higher transmission rate;
means for determining a destination address for a recipient device in the network from the first portion.

17. A device according to claim 16 which is arranged to instruct decoding of the second portion if the destination address matches an address for said device.

18. A device according to claim 16 wherein said determining means is further arranged to determine a duration identifier corresponding to the duration over which the network will remain occupied.

19. A device according to claim 16 wherein said determining means is further arranged to determine the transmission parameters of the second portion, and the length of the second portion, from the first portion.

20. A device according to claim 16 wherein the reception means is arranged to receive a packet having a BPSK OFDM.

21. A device according to claim 16 and further comprising means for transmitting a negative acknowledgement (NACK) to the device sending the packet if the device is unable to decode the second portion of the transmitted packet.

22. A device according to claim 21 wherein the NACK comprises the address of the device that sent the packet, or the device's address and not the address of the device that sent the packet.

23. A signal for use in a wireless network, the signal comprising a packet format having a first portion comprising a destination address for a recipient device in the network, and a second portion; wherein the first portion has a predetermined transmission rate, the second portion has a higher transmission rate.

24. A signal according to claim 23 further comprising a duration identifier corresponding to the duration over which the network will remain occupied.

25. A signal according to claim 23 wherein the first portion is an OFDM symbol having a BPSK modulation rate.

26. A method of transmitting a packet in a wireless network and comprising:
generating said packet comprising a first portion having a destination address for a recipient device in the network, and a second portion;
transmitting the first portion at a predetermined transmission rate, and transmitting the second portion at a higher transmission rate.

27. A method according to claim 26 wherein the first portion further comprises a duration identifier corresponding to the duration over which the network will remain occupied.

28. A method according to claim 27 wherein the first portion further comprises the transmission parameters of the second portion, and the length of the second portion.

29. A method according to claim 26 wherein BPSK OFDM is employed for transmitting the first portion.

30. A method according to claim 29 operating according to an IEEE 802.11 standard.

31. A method according to claim 26 wherein the step of generating comprises determining the destination address from the second portion.

32. A method according to claim 31 wherein the destination address is copied from the second portion.

33. A method according to claim 31 wherein the destination address is a shortened version of the address from the second portion.

34. A method according to claim 30 wherein the destination address is the recipient device's association identifier.

35. A method according to claim 26 further comprising receiving a negative acknowledgement (NACK) from the intended recipient of the transmitted packet.

36. A method according to claim 35 wherein the NACK comprises feedback information.

37. A method according to claim 35 and further comprising re-transmitting the packet.

38. A method according to claim 37 where the second portion is transmitted at a lower transmission rate than for the second portion of the first transmission.

39. A device according to claim 36 wherein the NACK comprises the device's address, or the intended recipient's address and not the devices address.

40. A method of receiving a packet in a wireless network and comprising:
receiving a first portion of the packet at a predetermined transmission rate, and receiving a second portion at a higher transmission rate;
determining a destination address for a recipient device in the network from the first portion.

41. A method according to claim 40 further comprising instructing decoding of the second portion if the destination address matches an address for said device.

42. A method according to claim 40 wherein said destination address determining step comprises determining a duration identifier corresponding to the duration over which the network will remain occupied.

43. A method according to claim 40 wherein said destination address determining step determining further comprises determining the transmission parameters of the second portion, and the length of the second portion, from the first portion.

44. A method according to claim 40 and further comprising transmitting a negative acknowledgement (NACK) to the device sending the packet if the device is unable to decode the second portion of the transmitted packet.

45. A method according to claim 44 wherein the NACK comprises the address of the device that sent the packet, or the device's address and not the address of the device that sent the packet.

46. A processor code product comprising processor code arranged to implement when run on a processor a method according to claim 26.

47. A processor code product comprising processor code arranged to implement when run on a processor a method according to claim 40.
